(19) United States
(12) Patent Application Publication
(10) Pub. No.: US 2015/0089539 A1
(43) Pub. Date: Mar. 26, 2015

(54) SYSTEM, APPARATUS, AND PROCESS FOR PROVIDING SPECTATOR INTERFACE

(71) Applicant: TAIT TOWERS MANUFACTURING, LLC, Lititz, PA (US)

(72) Inventor: Adam DAVIS, Leola, PA (US)

(73) Assignee: TAIT TOWERS MANUFACTURING, LLC, Lititz, PA (US)

(21) Appl. No.: 14/034,814

(22) Filed: Sep. 24, 2013

(51) Int. Cl. H04N 21/414; H04N 21/478; H04N 21/81

(52) U.S. Cl. CPC H04N 21/414; H04N 21/812; H04N 21/47815
USPC 725/34; 725/37; 725/60

(57) ABSTRACT

Disclosed are a system and a spectator interface apparatus. The system includes a plurality of spectator interface apparatuses, each spectator interface apparatus including at least one display device, the at least one display device forming a portion of a continuous image within a spectator region of a venue, and at least one interface device. The at least one display device and the at least one interface device are mounted on or in close proximity to a row of spectator seating, and each interface device corresponds to an individual spectator seat. The spectator interface apparatus includes at least one display device on a front side of the spectator interface apparatus, and at least one interface device on a rear side of the spectator interface apparatus. The interface device comprises an input component and a display component. Also disclosed is a process for providing spectator interface.

### FIELD OF THE INVENTION

The present invention is directed to a system, an apparatus, and a process for providing spectator interface. More specifically, the present invention is directed to a system, an apparatus, and a process for providing individualized spectator interface.

### BACKGROUND OF THE INVENTION

During events at various venues for housing large numbers of spectators, it is very difficult to provide any type of individualized experience. With a large number of spectators most advertisements and displays must be directed to a venue as a whole. There is also a lack of interaction between the individual spectators and the events occurring in the venue.

Additionally, it is difficult for spectators to purchase concessions without missing a portion of the event and/or distracting other spectators. Furthermore, during intermissions the concessions are often crowded, resulting in spectator frustration, employee stress, and lost sales. Known interface devices suffer from the drawbacks of an inability to provide individualized responses, spectator location, and/or formation of continuous displays within spectator portions of the venue.

A system, an apparatus, and a process for providing spectator interface that do not suffer from one or more of the above drawbacks would be desirable in the art.

### BRIEF DESCRIPTION OF THE INVENTION

In an exemplary embodiment, a system includes a plurality of spectator interface apparatuses, each spectator interface apparatus including at least one display device, the at least one display device forming a portion of a continuous image within a spectator region of a venue, and at least one interface device. The at least one display device and the at least one interface device are mounted on or in close proximity to a row of spectator seating, and each interface device corresponds to an individual spectator seat.

In another exemplary embodiment, a process for providing a spectator interface apparatus includes mounting at least one interface device on or in close proximity to a first row of spectator seating within a spectator region of a venue, each interface device comprising a display component and an input component, positioning each interface device to correspond with an individual spectator seat in a second row of spectator seating, permitting a spectator in the individual spectator seat to provide a spectator input with the input component, and providing an individualized response to the spectator input.

In another exemplary embodiment, a spectator interface apparatus includes at least one display device on a front side of the spectator interface apparatus, and at least one interface device on a rear side of the spectator interface apparatus. The interface device comprises an input component and a display component.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an exemplary display at a venue, according to the disclosure.

FIG. 2 is an enlarged cutaway front view of an exemplary display, according to the disclosure.

FIG. 3 is a perspective front view of an exemplary display device, according to the disclosure.

FIG. 4 is a perspective rear view of an exemplary display device, according to the disclosure.

FIG. 5 is an enlarged cutaway rear view of an exemplary display, according to the disclosure.

FIG. 6 is a schematic of an exemplary display system, according to the disclosure.

Wherever possible, the same reference numbers will be used throughout the drawings to represent the same parts.

### DETAILED DESCRIPTION OF THE INVENTION

Provided is a display device, a system for creating a display, and a process of creating a display. Embodiments of the present disclosure create an illusion of a continuous image, create an illusion of three-dimensional objects or images, provide a graphic display with the desired level of brightness and resolution of an enlarged digital image, permit still or moving images to be displayed as an array within a spectator region of a venue, and permit spectator interaction with the system.

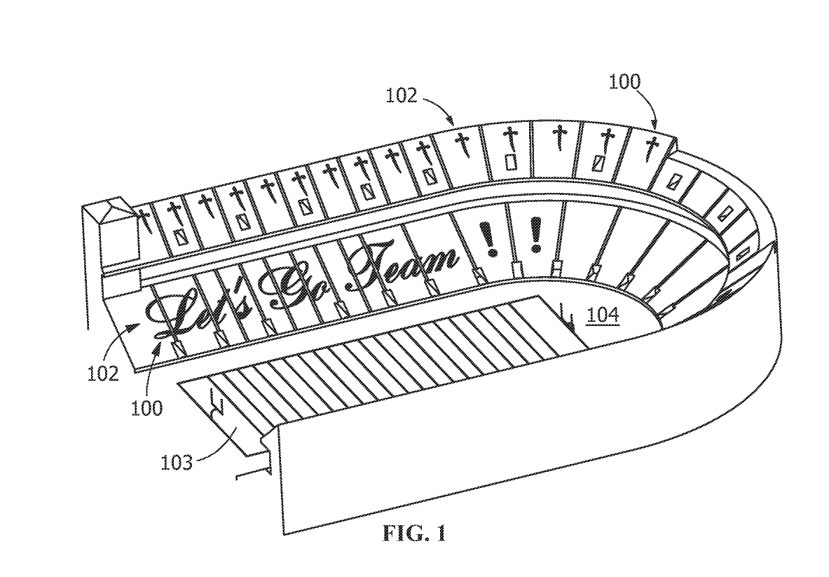

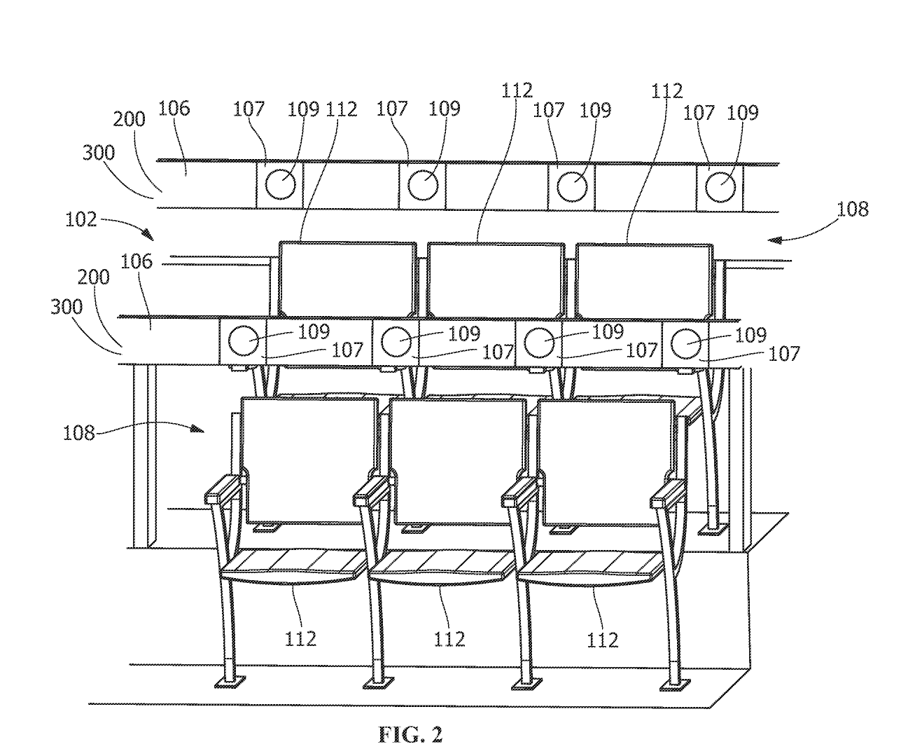

Referring to FIGS. 1 and 2, in one embodiment, a display 100 within a spectator region 102 of a venue 104 is shown. The spectator region 102 is located in any suitable venue 104 and is an area capable of arranging people in a configuration desirable for viewing an event, such as a sporting or entertainment event. Examples include a sports stadium, concert, or other performance. The spectator region 102 is located in any suitable environment, such as outdoors, exposed to ambient conditions, indoors, underwater, or partially exposed, for example, or combinations thereof. In one embodiment, rows 108 including at least one individual spectator seat 112 are arranged and disposed within the spectator region 102. The rows 108 are positioned in any suitable arrangement, such as multi-level, staggered, tiered, curved, or single-level, for example, or combinations thereof. In another embodiment, the display 100 is arranged and disposed within a non-spectator region 103. The non-spectator region 103 includes any suitable non-spectator region, such as, a playing field, performance stage, dugouts or other player area, band or orchestra area, media/announcer area, concessions, ticket or merchandizing area, or parking lots, for example.

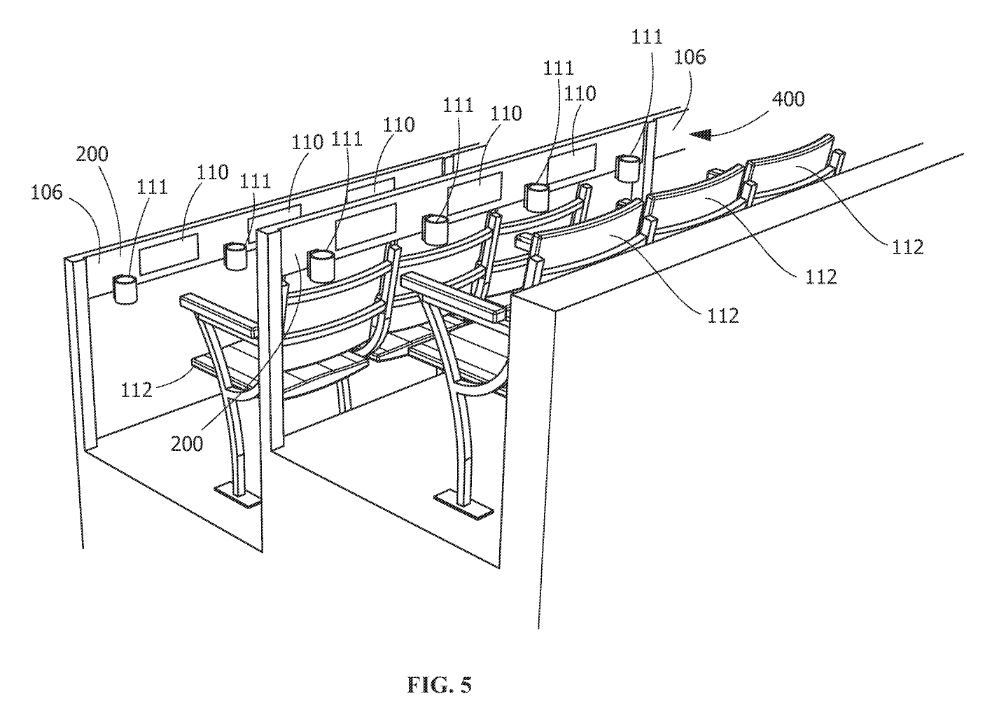

In one embodiment, a plurality of spectator interface apparatuses 200 are positioned within the spectator region 102. In another embodiment, each spectator interface apparatus 200 is positioned on or in close proximity to a single row 108 of the individual spectator seats 112. The spectator interface apparatuses 200 include at least one display device 107, at least one interface device 110 (FIG. 5), and a support 106 for mounting the at least one display device 107 and the at least one interface device 110. The support 106 may be any suitable support, such as, but not limited to, handrails, pipes, bars, tubes, ledges, walls, or a combination thereof. In another embodiment, the support 106 includes a suitable resilient or elastomeric material to provide improved gripping and/or shock absorption.

In one embodiment, the spectator interface apparatuses 200 are powered from a local power source, such as one or more batteries arranged and disposed therein. In one embodiment, the spectator interface apparatuses 200 are powered by an external power source provided by power wirings such as a power cord, for example. In one embodiment, the power source and/or power wiring is run inside of a cable housing. In another embodiment, the cable housing may be positioned on or within the support 106. In a further embodiment, the support 106 may include an opening therein to serve as the cable housing.

The display device 107 includes a housing mounted to a front side 300 of the spectator interface apparatus 200, the housing fabricated of a durable, moldable polymeric material, or any other suitable durable material capable of supporting a predetermined structural load and resisting impact fractures. In one embodiment, at least one display device 107 corresponds to each individual spectator seat 112. Each display device 107 is arranged and disposed on the front side 300 of the spectator interface apparatus 200 to face the same, or generally the same, direction as the individual spectator seats 112. Each display device 107 further includes one or more light emitting elements 109.

In one embodiment, one or more of the display devices 107 are positioned between individual spectator seats 112 situated adjacent to each other. In another embodiment, the display devices 107 are arranged and disposed to be spaced apart some predetermined distance from adjacent display devices 107. A suitable predetermined spacing distance includes, but is not limited to, from about 20 inches to about 4 feet, from about 20 inches to about 3 feet, from about 20 inches to about 30 inches, from about 2 feet to about 3 feet, from about 3 feet to about 4 feet, or any suitable range therein. In one embodiment, the predetermined spacing distance between the display devices 107 is approximately the same distance as the center-to-center spacing of the individual spectator seats 112 situated adjacent to each other.

The one or more light emitting elements 109 may include light emitting diodes (LEDs), for example, or any suitable light emitting elements 109, such as, video strips, organic light emitting diodes (OLEDs), fiber optic lights, fluorescent lights, incandescent lights, neon lights, polymer light emitting diodes, electroluminescent lights, or combinations thereof. In one embodiment, the light emitting elements 109 include a grouping of red, green and blue LEDs, although in other embodiments, different numbers and colors of light emitting elements 109 are used. The display devices 107 are a single unitary construction capable of providing a range of colored light and/or a range of intensity of light or a combined construction capable of providing the range of colored light and/or the range of intensity of light. In one embodiment, the light emitting elements 109 are configured for a modular grouping connected to a suitable board, such as a pluggable printed circuit board, for example, and are capable of quick disconnection from the display device 107 for changing in or out.

In one embodiment, display coordinates corresponding to a row 108 and seat number for one or more individual spectator seat 112, such as 8A, 8B, 8C, 9A, 9B, 9C, for example, create a two-dimensional array map. The individual spectator seats 112 correspond with the display coordinates within the array map. An example of such display coordinates that are used to create the display 100 include display coordinates corresponding to seat numbers 18CC, 19BB, 19CC, 20BB, 20CC, 21AA, 21BB, 22AA, 22BB, 23AA, 23BB, 24Z, 24AA, 24BB, 25Z, 25AA, 25BB, 26Y, 26Z, 26AA, 27Y, 27Z, 27AA, 28Y, 28Z, 28AA, 29X, 29Y, 29Z, 29AA, 30X, 30Y, 30Z, 30AA, 31W, 31X, 31Y, 31Z, 32W, 32X, 32Y, 32Z, 33V, 33W, 33X, 33Y, 33Z, 34V, 34W, 34X, 34Y, 34Z, 35U, 35V, 35W, 35X, 35Y, 36U, 36V, 36W, 36X, 36Y, 37U, 37V, 37W, 37X, 37Y, 37T, 38U, 38V, 38W, 38X, 39T, 39U, 39V, 39W, 39X, 40T, 40U, 40V, 40W, 40X, 41T, 41U, 41V, 41W, 41X, 42T, 42U, 42V, 42W, 42X, 43T, 43U, 43V, 43W, 43X, 44T, 44U, 44V, 44W, 44X, 45T, 45U, 45V, 45W, 45X, 460, 46P, 46Q, 46R, 46S, 46T, 46U, 46V, 46W, 46X, 46Y, 46Z, 46AA, 46BB, 46CC, 470, 47P, 47Q, 47R, 47S, 47T, 47U, 47V, 47W, 47X, 47Y, 47Z, 47AA, 47BB, 47CC, 480, 48P, 48Q, 48R, 48S, 48T, 48U, 48V, 48W, 48X, 48Y, 48Z, 48AA, 48BB, 48CC, 490, 49P, 49Q, 49R, 49S, 49T, 49U, 49V, 49W, 49X, 49Y, 49Z, 49AA, 49BB, 49CC, 50T, 50U, 50V, 50W, 50X, 51T, 51U, 51V, 51W, 51X, 52T, 52U, 52V, 52W, 52X, 53T, 53U, 53V, 53W, 53X, 54T, 54U, 54V, 54W, 54X, 55T, 55U, 55V, 55W, 55X, 56T, 56U, 56V, 56W, 56X, 57S, 57T, 57U, 57V, 57W, 57X, 58S, 58T, 59U, 59V, 59W, 59X, 59S, 59T, 59U, 59V, 59W, 59X, and 60U, 60V. In another embodiment, each of the display devices 107 is electronically assigned the corresponding individual spectator seat 112 display coordinates within the array map.

In one embodiment, one or more of the light emitting elements 109 in the at least one display device 107 is activated to form the display 100. In another embodiment, the light emitting elements 109 in the display devices 107 of the display 100 create the illusion of a continuous image when viewed from a suitable distance within or beyond the venue 104. In one embodiment, the display 100 represents suitable three-dimensional objects or images, or landscapes, for example. In one embodiment, the image graphic represents text, or forms a text string creating a message. In one embodiment, the number and positioning of the light emitting elements 109 is suitable to provide the desired visual, video or combined image effect.

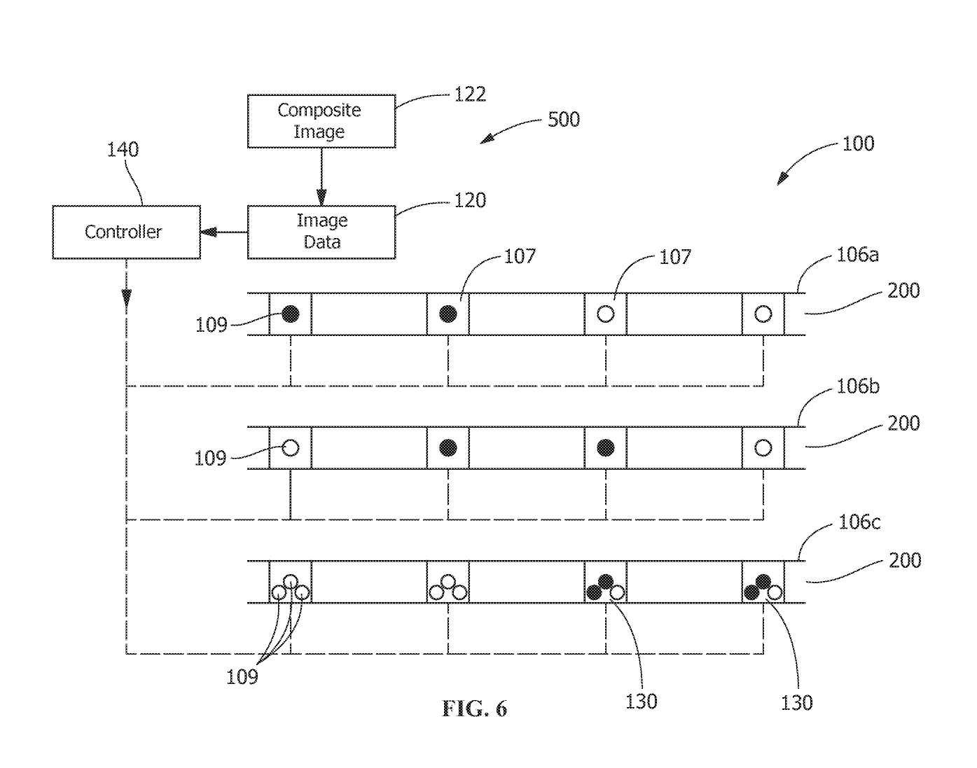

In one embodiment, the activation of one or more of the light emitting elements 109 includes various control functions, such as independently turning the display capability of the display devices 107 on or off, for example. In one embodiment, the activation further includes independently controlling a level of intensity of the light emitting elements 109 to vary the brightness of light displayed, and/or independently controlling the light emitting elements 109 to vary the color displayed by each of the light emitting elements 109. In another embodiment, the light emitting elements 109 emit multiple colors of light simultaneously or at different times. In one embodiment, the activation includes various control sequences of operation such as independently controlling the light emitting elements 109 to vary the duration and sequences of light displayed, for example. In one embodiment, activation includes controlling all of the one or more light emitting elements 109 simultaneously. In one embodiment, activation includes controlling only a portion of the one or more light emitting elements 109. In another embodiment, activation includes any combination of the above controls, or control of any suitable other features and properties of the display device 107 affecting the formation of the display 100 and/or a pixel image 130 (FIG. 6).

In one embodiment, for example, the activation of one or more of the light emitting elements 109 within the display device 107 to form the pixel image 130 is controlled to include at least one of the light emitting elements 109 emitting red light at 50 percent intensity while the remaining light emitting elements 109 emit white light at 100 percent intensity, both simultaneously, for a duration of one minute. In one embodiment, the range of light intensity simultaneously displayed on one display device 107 is from about 30 percent to about 100 percent, from about 30 percent to about 50 percent, or from about 60 percent to about 80 percent, or any suitable range therein.

In one embodiment, each spectator interface apparatus 200 includes one or more display controllers. In another embodiment, the one or more display controllers are configured to control at least one of the plurality of light emitting elements 109 in the display device 107. In a further embodiment, each display device 107 includes at least one display controller. In one embodiment, the display controller is an independently controlled addressable controller.

In one embodiment, the display device 107 includes an element controller configured for control of each individual light emitting elements 109. In another embodiment, each display device 107 includes one or more independently controlled light emitting elements 109. In one embodiment, the element controller is an independently controlled addressable controller. In one embodiment, the display controller controls one or more of the element controllers. The light emitting elements 109 are controlled by any suitable single controller or series of controllers, such as a microprocessor, for example, which coordinate display of images and/or video. In one embodiment, the element controllers are programmable controllers.

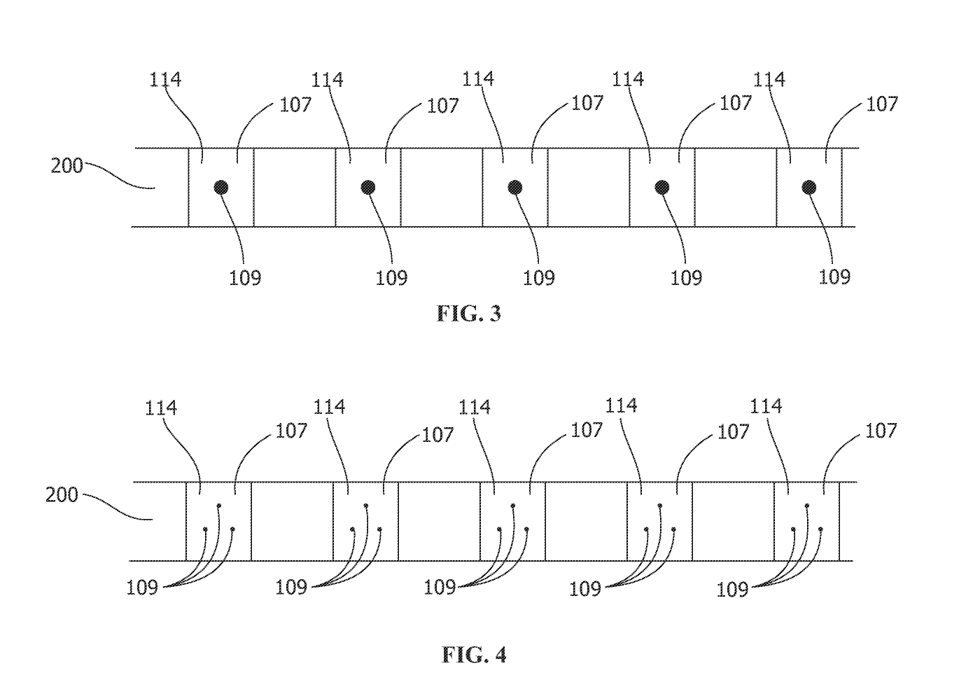

Referring to FIGS. 2-4, the spectator interface apparatus 200 includes a front side having at least one display device 107, and one or more light emitting elements 109 within each display device 107. In another embodiment, a cover panel 114 is positioned over the at least one light emitting element 109. The cover panel 114 is configured to allow light transmission while providing protection to the light emitting elements 109. In one embodiment, the cover panel 114 is fabricated of a transparent polycarbonate with a scratch and UV resistant, antireflective coating, or any other suitable durable transparent or semi-transparent or semi-translucent material capable of supporting a predetermined structural load (as if sat or stepped upon, for example), and resisting cracking if subjected to an impact force.

Referring to FIG. 5, in one embodiment, one or more of the interface devices 110 are mounted to a rear side 400 of the spectator interface apparatus 200. In another embodiment, the rear side 400 includes one or more cup holders 111 or other receptacle for spectator comfort. In another embodiment, the one or more interface devices 110 and/or one or more cup holders 111 correspond to one or more of the individual spectator seats 112. In a further embodiment, each individual spectator seat 112 has a corresponding interface device 110. The interface device 110 corresponding to each individual spectator seat 112 permits identification of the corresponding individual spectator seat 112 and provides individualized visual output and/or individualized responses to spectator input with the interface device 110.

The interface device 110 includes an input component and/or a display component. The input component is any suitable input component for permitting the spectator in the individual spectator seat 112 to provide spectator input. A suitable input component includes, but is not limited to, a key pad, a digital input, a push button, or a combination thereof. When the spectator provides any suitable spectator input to the input component, the interface device 110 provides a corresponding individualized response. Suitable spectator inputs include, but are not limited to, placing an order with a concession stand, interacting with an event in the venue 104, interacting with the display 100, controlling the display device 107 corresponding with the individual spectator seat 112, placing a vote, answering a question, or a combination thereof

In another embodiment, the display component of the interface device 110 provides visual and/or audio output to the spectator. For example, in a further embodiment, the display component provides visual output on a screen, such as, but not limited to, a liquid-crystal display (LCD), a light-emitting diode (LED), or an organic light-emitting diode (OLED). The visual output includes any suitable video, image, and/or text, such as, but not limited to, advertisements, menus, highlights, live feed, questions, any other individualized visual output, or a combination thereof.

In one embodiment, the display component is coupled to the input component to solicit input from the spectator through the input component, and/or to modify the visual output in response to the spectator input. For example, the visual output from the display component may include a menu having a plurality of items, when the spectator makes a selection using the spectator input, the visual output is modified to reflect the spectator selection. In another embodiment, the interface device 110 provides the display component and the input component in a single combined input/output component. For example, in one embodiment, the single combined input/output component includes, but is not limited to, a touch screen that both permits spectator input and provides visual output.

In one embodiment, the interface device 110 provides information to, and receives information from the display device 107. For example, in one embodiment, when the spectator provides input to the interface device 110, such as responding to a question on the display component, at least one of the light emitting elements 109 in the corresponding display device 107 is activated in response to the spectator's input.

Referring to FIG. 6, in one embodiment, a system 500 for creating the display 100, is shown. In one embodiment, the system 500 includes a plurality of the spectator interface apparatuses 200. One or more of the display devices 107 are mounted to each of the spectator interface apparatuses 200 and provided with image data 120. For example, as shown in FIG. 6, in one embodiment, the system 500 includes a first support 106a, a second support 106b, and a third support 106c, each support corresponding to one of the spectator interface apparatuses 200. Each of the spectator interface apparatuses 200 includes a plurality of the display devices 107. In another embodiment, at least a portion of the first support 106a is positioned within the spectator region 102 of the venue 104.

In one embodiment, each of the display devices 107 is configured to receive the image data 120 and activate the light emitting elements 109 in response to the image data 120. In another embodiment, each of the display devices 107 having more than one of the light emitting elements 109 is configured to selectively activate each of the light emitting elements 109 in response to the image data 120. The selective activation of each of the light emitting elements 109 forms the pixel image 130 or a sequence of pixel images 130 corresponding to the image data 120. Activating the one or more light emitting elements 109 in one or more of the display devices 107 in the plurality of the spectator interface apparatuses 200 forms the display 100 corresponding to the image data 120.

In one embodiment, the image data 120 provided is real-time data from a live feed. In one embodiment, the display controller is preprogrammed with image data 120. In one embodiment, the image that forms the display 100 is selected by input from one or more of the interface devices 110. For example, in another embodiment, a plurality of images are displayed on the display component for the spectators to choose from, and each spectator is able to make a selection using the input component of the interface device 110 corresponding to their individual spectator seat 112. The spectator selections are recorded, and the image data 120 corresponding to the image receiving the most selections is communicated to at least one of the plurality of display devices 107.

In one embodiment, the display device 107 is configured to activate the light emitting elements 109 in real-time or substantially real-time from a live feed, for example, with little or no image data manipulation, such as by interpolation, morphing, and/or dissolving. In one embodiment, the display devices 107 are driven by any suitable image, such as, still image, live image, predefined video, animated image, or interactive image, for example. The plurality of display devices 107 are arranged and disposed in the array map whereby the activated light emitting elements 109 forming the pixel images 130 and/or the solid lights are configured to form or create a substantially continuous image on the display 100, providing an illusion of a continuous image.

In one embodiment, a process of creating the display 100 having an illusion of a continuous image includes providing image data 120 to a plurality of display devices 107 and, as shown in FIG. 6, either activating or not activating each of the light emitting elements 109 in the plurality of display devices 107 to form the display 100 corresponding to the image data 120. In another embodiment, the process includes converting a composite image 122 into the image data 120.

In one embodiment, the composite image 122 is converted into the image data 120 through use of an interpolation rendering algorithm. In this embodiment, the composite image 122 (a three-dimensional model in a vector graphics format, for example), is converted into a raster image of pixels in a two-dimensional plane for output or for storage. In one embodiment, the rendering algorithm includes a perspective projection transformation utilizing a regenerated frustum as the intermediated form factor. In one embodiment, the interpolation rendering algorithm includes an interpolation scaling algorithm. The scaling algorithm is utilized to enlarge or scale up the image to create the display 100 in the desired venue 104, such as in a sports stadium, or concert, for example.

In one embodiment, the conversion of the composite image 122 into the image data 120 includes creating a full screen digital pixelated image having a plurality of digital pixels. In one embodiment, each digital pixel includes digital pixel image data. The digital pixel image data includes corresponding electronic properties, such as, position coordinates in a digital array grid, a predetermined color, and a predetermined intensity, for example. In one embodiment, the process further includes assigning all or a portion of the digital pixel image data to corresponding all or a portion of the corresponding individual spectator seat 112 display coordinates within the array map of the venue 104. In one embodiment, the image data 120 corresponds with a portion of the display 100. In one embodiment, the process further includes wherein the image data 120 includes the digital pixel image data.

In one embodiment, the image data 120 used to form the pixel image 130 takes into account the predetermined viewing angle of display 100 with respect to a surface or object, such as, a stage, a performer, or an overhead blimp, for example. In one embodiment, the conversion of the composite image 122 into the image data 120 includes utilizing the coordinates of a focal object at the venue, such as a stage performer, for example, as the focal point for determining one or more viewing angles for the pixel image 130.

In one embodiment, the image data 120 is communicated by a remote controller 140. In another embodiment, the remote controller 140 is capable of providing image data 120 to the display devices 107. In one embodiment, the remote controller 140 independently controls the display devices 107. In one embodiment, the control of the display devices 107 is provided by one or more controllers and includes any suitable programmable controller for coordinating video or image displays, such as, a computer, computing device, or processor, for example, or combinations thereof. In one embodiment, the remote controller 140 is operated by a predetermined suitable operator, such as, a performer, a player, an announcer, a producer, or a designated spectator (i.e., a winner of a privileged operator lottery or contest), for example.

In one embodiment, the display devices 107 are connected to each other and/or the remote controller 140 by any suitable connection, including, but not limited to, a wired connection, or other communication and/or power transmitting device. In one embodiment, control of the display devices 107 includes communication via a serial wired connection. In another embodiment, the wired connection is provided by wiring run inside the same cable housing as the power wiring. In one embodiment, the wired connection includes power and/or signal capability. For example, the wired connection includes one or more suitable electrical communication and/or power providing cables, such as fiber optic, coaxial cable, RCA cable, Ethernet cables, or copper-based wires or cables.

In one embodiment, control of the display devices 107 includes communication via a wireless connection, such as, through an infrared (IR), radiofrequency (RF), other suitable wavelengths, or any other electromagnetic signal, for example. In one embodiment, the stream of image data 120 is transmitted to all the display devices 107 to provide the desired visual display 100. The addressable capability of the display controller allows the individual display devices 107 to receive and process the specific image data 120 transmitted for that corresponding device. The system 500 utilizes suitable software, hardware, video signals, image signals, controllers, media servers, control devices and electronics, and combinations thereof, to generate, transmit, and process video and/or images and activate the light emitting elements 109 in the display devices 107 to form the display 100.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system, comprising:
a plurality of spectator interface apparatuses, each spectator interface apparatus comprising:
at least one display device, the at least one display device forming a portion of a continuous image within a spectator region of a venue; and
at least one interface device;
wherein the at least one display device and the at least one interface device are mounted on or in close proximity to a row of spectator seating; and
wherein each interface device corresponds to an individual spectator seat.

2. The system of claim 1, wherein each interface device comprises an input component.

3. The system of claim 2, wherein each interface device comprises a display component for providing visual output to a spectator.

4. The system of claim 3, wherein the interface device comprises a touch screen, the touch screen providing both the input component and the display component.

5. The system of claim 3, wherein the visual output is individualized for the spectator in the corresponding individual spectator seat.

6. The system of claim 1, wherein the interface device is arranged and disposed to permit input by an individual spectator in the corresponding individual spectator seat.

7. The system of claim 6, wherein the input is selected from the group consisting of ordering concessions, responding to the visual output on the display component, interacting with other spectators, and providing information for activation of the at least one display device.

8. The system of claim 1, wherein the at least one display device is capable of receiving image data.

9. The system of claim 8, wherein the interface device corresponding to the individual spectator seat permits an individual spectator to provide input forming at least a portion of the image data.

10. The system of claim 9, wherein each of the at least one display devices includes a light emitting element capable of being activated in response to the image data.

11. A process for providing a spectator interface apparatus, the process comprising:
mounting at least one interface device on or in close proximity to a first row of spectator seating within a spectator region of a venue, each interface device comprising a display component and an input component;
positioning each interface device to correspond with an individual spectator seat in a second row of spectator seating;
permitting a spectator in the individual spectator seat to provide a spectator input with the input component; and
providing an individualized response to the spectator input.

12. The process of claim 11, further comprising providing an individualized visual output on the display device.

13. The process of claim 12, wherein the individualized visual output comprises advertising.

14. The process of claim 12, further comprising modifying the individualized visual output in response to the spectator input.

15. The process of claim 11, wherein the individualized response comprises activation of the at least one display device.

16. The process of claim 15, wherein the at least one display device forms a portion of a continuous image within the spectator region of the venue.

17. The process of claim 11, wherein the individualized response comprises identifying the individual spectator seat corresponding to the interface device, and providing a physical response at the individual spectator seat.

18. The process of claim 17, wherein the spectator input comprises ordering concessions, and the physical response comprises delivery of the concessions to the individual spectator seat.

19. A spectator interface apparatus, comprising:
at least one display device on a front side of the spectator interface apparatus; and
at least one interface device on a rear side of the spectator interface apparatus;
wherein the interface device comprises an input component and a display component.

20. The spectator interface apparatus of claim 19, further comprising a plurality of display devices on the front side and a plurality of interface devices on the rear side.
